(19) United States
(12) Patent Application Publication
(10) Pub. No.: US 2017/0254601 A1
(43) Pub. Date: Sep. 7, 2017

(54) THERMAL ENERGY STORAGE SYSTEMS COMPRISING ENCAPSULATED PHASE CHANGE MATERIALS AND A NEUTRALIZING AGENT

(71) Applicant: ENTROPY SOLUTIONS LLC, Plymouth, MN (US)

(72) Inventors: William Rusty SUTTERLIN, Hoover, AL (US); Steven Keith MCNEIL, Tuscaloosa, AL (US)

(21) Appl. No.: 15/448,578

(22) Filed: Mar. 2, 2017

Related U.S. Application Data
(60) Provisional application No. 62/304,025, filed on Mar. 4, 2016.

(51) Int. Cl. F28D 20/02; F28F 23/00; F28F 27/00; C09K 5/06

(52) U.S. Cl. CPC F28D 20/023; C09K 5/063; F28F 23/00; F28F 27/00; F28D 2021/0035

(57) ABSTRACT

Provided are Thermal Energy Storage (TES) systems comprising Phase Change Material (PCMs) compositions for thermal management in different applications such as building, automotive, and industrial applications. Provided are TES systems comprising encapsulated PCMs and a heat transfer medium comprising a neutralizing agent and/or an ion exchange resin capable of neutralizing the acidic or basic PCM contained in the capsules, should the PCM permeate the walls of the capsules or otherwise be released into the surrounding heat transfer medium.

### RELATED APPLICATIONS

This application claims benefit of priority under section 35 USC 119(e) to U.S. provisional patent application Ser. No. 62/304,025, filed Mar. 4, 2016, the entire contents of which are incorporated herein, in their entirety.

### FIELD OF THE INVENTION

This invention generally relates to thermoregulation, thermal protection and insulation, Phase Change Material (PCMs) and nucleating agents. In particular, in alternative embodiments, provided are Thermal Energy Storage (TES) systems comprising Phase Change Material (PCMs) compositions for thermal management in different applications such as building, automotive, and industrial applications. Provided are TES systems comprising encapsulated or contained PCMs and a heat transfer medium comprising a neutralizing agent capable of neutralizing the acidic or basic PCM contained in the capsules, should the PCM permeate through the walls of the capsules or otherwise be released into the surrounding heat transfer medium.

### BACKGROUND OF THE INVENTION

There is a general desire in all industries to be energy efficient. There is also a general desire to reduce the use of fossil fuel resources due to concerns over climate change and energy security. Buildings, for example, require significant amounts of energy for heating and cooling and there is a need to reduce the costs associated with thermal management. Energy capture and storage from buildings and the controlled release of stored energy back into the building is increasingly viewed as a critical component to reducing overall energy demand in commercial and industrial applications. The thermal management of temperature sensitive payloads during transport can also require significant amounts of energy. In the automotive industry, there is a desire to increase efficiency and reduce the fuel usage associated with maintaining a comfortable temperature in the cabin of vehicles.

One approach of decreasing the amount of energy needed for thermal management is the use of phase change materials. A “phase change material” (PCM) is a material that stores or releases a large amount of energy during a change in state, or “phase”, e.g. crystallization (solidifying) or melting (liquefying) at a specific temperature. The amount of energy stored or released by a material during crystallization or melting, respectively, is the latent heat of that material. During such phase changes, the temperature of the material remains relatively constant. This is in contrast to the “sensible” heat, which does result in a temperature change of the material, but not a phase change.

PCMs are therefore “latent” thermal storage materials. A transfer of energy occurs when the material undergoes a phase change, e.g. from a liquid to a solid and thus helps to maintain the temperature of a system. When heat is supplied to the system in which the temperature is at the melting point of the PCM, energy will be stored by the PCM, resulting in a mediating effect on the temperature of the system. Similarly, when the temperature of the system decreases to the crystallization temperature of the PCM, the energy stored by the PCM will be released into the surrounding environment. The amount of energy stored or released by a material is a constant, and is that material's latent heat value. For example, water has a latent heat of 333 J/g. Therefore, a gram of water will release 333 J of energy to its surrounding environment during crystallization (freezing), at 0° C. without changing temperature. Similarly, a gram of frozen water will absorb 333 J of energy from its surrounding environment during melting without an increase in temperature from 0° C.

There are two primary characteristics that must be considered for a specific application of a PCM: 1) the melting/crystallization temperature of the material, and 2) the latent heat value. A high latent heat value is the most desirable characteristic of a phase change material. A high latent heat value means that the material will be able to store or release large amounts of energy during a phase change, thus reducing the quantity of supplied energy needed to heat or cool a system. A latent heat value of 160 J/g or higher is considered acceptable for a PCM material in thermal storage applications. The melting/crystallization temperature is important because every thermal storage system has a unique optimal temperature range. These two factors together inform the potential applications for a specific PCM. For example, although water has a very high latent value (333 J/g), it would not be suitable for use as a PCM in building materials, as buildings are typically maintained at temperatures around 70° F. (21° C.), well above the melting/crystallization temperature of water.

The majority of commercially available PCMs are salt hydrates or paraffins. Both salt hydrates and paraffins have inherent disadvantages in commercial applications. Salt hydrates, while cheap to produce, have inconsistent melting points, and have a tendency to supercool (a process in which the temperature of a material is lowered to below its melting point without the material undergoing crystallization). Salt hydrates are also known to undergo significant thermal expansion and can be highly toxic and corrosive. Paraffins make suitable PCMs in that they have favorable latent heat values and consistent melting points. However, the high latent heats of paraffin-based PCMs (in excess of 230 J/g) require compositions comprising high purities of paraffins, necessitating the use of expensive processing technology. Further, paraffins are limited in their potential range of phase change temperatures, leading to the use of mixed PCM compositions with reduced latent heat values.

Other concerns with paraffins used as PCMs are related social dynamics. Paraffins are made from petroleum products, which increase reliance on crude oil. Paraffin prices have followed the unstable price of petroleum. Furthermore, petroleum derived paraffins have geopolitical consequences and contribute to the increase in carbon emissions blamed for the global warming crisis.

The lifecycle of a thermal energy storage system that contains a PCM is dependent on the compatibility of the PCM with the materials that comprise the remainder of the system. A disadvantage of conventional PCMs is their reactivity with metallic materials that are common in many industrial applications including carbon steel, copper, stainless steel, and aluminum, leading to oxidation and corrosion of the surrounding materials. Conventional PCMs can also react with non-metallic polymers, or be absorbed by the polymers over time. Over time, these structural changes in the thermal energy storage system lead to a decrease in efficiency of the system and an increase in costs associated with material replacement and energy use.

### SUMMARY OF THE INVENTION

In alternative embodiments, provided are thermal energy management systems comprising a) at least a first container or compartment and a second container or compartment, each defining or having an interior volume or interior compartment, wherein the first container or compartment and the second container or compartment are in operable connection to each other such that a fluid or heat transfer medium initially stored in the second container or compartment can pass to or into the first container or compartment, and optionally the operable connection comprises a valve or a valve system capable of directing or controlling the flow of the fluid or heat transfer medium from the second container or compartment to or into the first container or compartment, and optionally the system further comprises an operable connection between the first container or compartment and the second container or compartment such that the fluid or heat transfer medium can be re-circulated from the first container or compartment back to the second container or compartment in a continuous fashion, b) a plurality of capsules or other suitable containers stored or contained in the first container or compartment, wherein the plurality of capsules comprise, or have contained within an interior volume, at least one phase change material (PCM) possessing an acidic or basic property or a PCM capable of forming an acid or a base after reacting with the heat transfer medium, c) a heat source operationally connected to the second container or compartment, wherein the heat source is capable of heating the fluid or heat transfer medium in the second container or compartment to above the melting point of the PCM, d) a fluid or heat transfer medium stored or contained in the second container or compartment, wherein the fluid or heat transfer medium comprises a composition or a material, or the fluid or heat transfer medium itself is, capable of reacting with the PCM to generate a neutral, non-reactive products, wherein the fluid or heat transfer medium absorbs sufficient thermal energy from the heat source to heat the fluid or heat transfer medium to above the melting point of the PCM, and the heated fluid or heat transfer medium is subsequently transferred from the second container or compartment to the first container or compartment, thereby heating the PCM in the plurality of capsules to above the melting point of the PCM and removing at least a portion of the thermal energy from the fluid or heat transfer medium and storing it in the PCM as a latent heat.

In alternative embodiments, the thermal energy management system comprises a PCM having a latent heat value of 160 J/g or higher.

In alternative embodiments, provided are methods for managing thermal energy comprising providing an encapsulated PCM, wherein the PCM is comprised of an acid or a base, or the PCM is an acidic or a basic phase change material (PCM); providing a heat transfer medium comprising an acid or basic neutralizing agent, and when sufficiently heated the heat transfer medium is capable of heating the PCM to above the melting point of the PCM, and/or, providing an ion exchange resin capable of neutralizing or adsorbing the PCM comprised of an acid or base or an acidic or a basic PCM; heating the heat transfer medium in a first area or compartment with a temperature above the melting point of the PCM; and, circulating the heated heat transfer medium from the first area or compartment to a second area or compartment comprising the encapsulated PCM, thereby contacting the encapsulated PCM with the heat-transfer medium and both neutralizing the acidic or basic PCM, circulating the heat transfer medium through the ion exchange resin neutralizing the acidic or basic free PCM, and heating the PCM to a temperature above the melting point of the PCM.

In alternative embodiments, provided are thermal energy management systems, and methods using thermal energy management systems as provided herein, that incorporate use of, a PCM having a latent heat value of 160 J/g or higher.

In alternative embodiments, provided are thermal energy management systems, and methods using thermal energy management systems as provided herein, that comprise a PCM, and optionally the PCM is selected from the group consisting of: fatty acids, fatty acid derivatives, salt hydrates, eutectic mixtures, organic phase change materials which possess acidic or basic properties, and mixtures thereof.

In alternative embodiments, provided are thermal energy management systems, and methods using thermal energy management systems as provided herein, that comprise a basic neutralizing agent, wherein optionally the basic neutralizing agent is selected from the group consisting of: organolithiums, amines, N-heterocyclic compounds, tetraalkylammonium and phosphonium hydroxides, metal alkoxides and amides, metal silanoates, inorganic salts, oxides, carbonates, bicarbonates, sulfates, and mixtures thereof.

In alternative embodiments, provided are thermal energy management systems, and methods using thermal energy management systems as provided herein, that comprises an acid neutralizing agent, wherein optionally the acid neutralizing agent is selected from the group consisting of: hydrogen halides, inorganic acids, sulfonic acids, carboxylic acids, phenols, bisulfates, and a mixture thereof.

In alternative embodiments, provided are thermal energy management systems and methods using thermal energy management systems as provided herein, that comprises an ion exchange resin capable of neutralizing or removing the free PCM, wherein optionally the ion exchange resin is selected from the group consisting of: strong anionic resins, weak anionic resins, strong cationic resins, weak cationic resins, and mixtures thereof.

In alternative embodiments, provided are thermal energy management systems, and methods using thermal energy management systems as provided herein, that comprising:
a. at least a first container or compartment and a second container or compartment, each defining or having an interior volume or interior compartment;
wherein the first container or compartment and the second container or compartment are in operable connection to each other such that a fluid or heat transfer medium initially stored in the second container or compartment can pass to or into the first container or compartment;
and optionally the operable connection comprises a valve or a valve system capable of directing or controlling the flow of the fluid or heat transfer medium from the second container or compartment to or into the first container or compartment;
and optionally the system further comprises an operable connection between the first container or compartment and the second container or compartment such that the fluid or heat transfer medium can be re-circulated from the first container or compartment back to the second container or compartment in a continuous fashion;
b. a plurality of capsules stored or contained in the first container or compartment, wherein the plurality of capsules comprise, or have contained within an interior volume, at least one acidic or basic phase change material (PCM);
c. a heat source operationally connected to the second container or compartment, wherein the heat source is capable of heating the fluid or heat transfer medium in the second container or compartment to above the melting point of the PCM; and
d. a fluid or heat transfer medium stored or contained in the second container or compartment, wherein the fluid or heat transfer medium comprises a composition or a material, or the fluid or heat transfer medium itself is, capable of reacting with the PCM to generate a neutral, non-reactive product;
wherein the fluid or heat transfer medium absorbs sufficient thermal energy from the heat source to heat the fluid or heat transfer medium to above the melting point of the PCM, and the heated fluid or heat transfer medium is subsequently transferred from the second container or compartment to the first container or compartment, thereby heating the PCM in the plurality of capsules to above the melting point of the PCM and removing at least a portion of the thermal energy from the fluid or heat transfer medium and storing it in the PCM as a latent heat.

In alternative embodiments, or the thermal energy management systems the PCM has a latent heat value of 160 J/g or higher or between about 160 J/g and 180, 200, 220, 240 or 260 J/g.

In alternative embodiments, provided are methods for managing thermal energy comprising:
a. providing an encapsulated PCM, wherein the PCM is comprised of an acid or a base, or the PCM is an acidic or a basic phase change material (PCM);
b. providing a heat transfer medium comprising an acid or basic neutralizing agent or flowing through an ion exchange resin bed, and when sufficiently heated the heat transfer medium is capable of heating the PCM to above the melting point of the PCM;
c. heating the heat transfer medium in a first area or compartment with a temperature above the melting point of the PCM; and
d. circulating the heated heat transfer medium from the first area or compartment to a second area or compartment comprising the encapsulated PCM, thereby contacting the encapsulated PCM with the heat-transfer medium and both neutralizing the acidic or basic PCM, and heating the PCM to a temperature above the melting point of the PCM.

In alternative embodiments of the thermal energy management systems, or the methods of using them:
the PCM is an acidic PCM, and optionally the PCM is or comprises at least one a fatty acid or a fatty acid derivative, and optionally the fatty acid comprises a C2 to C40 alkyl or alkene chain, or comprises a substituted C2 to C40 alkyl or alkene chain;
the PCM is, or comprises: a basic PCM; an ester; a salt hydrate; a eutectic mixture, or a combination thereof.

In alternative embodiments, the thermal energy management systems as provided, or the method for managing thermal energy as provided herein, herein further comprise, or further comprise use of, a basic neutralizing agent, wherein optionally the basic neutralizing agent is selected from the group consisting of: organolithiums, amines, N-heterocyclic compounds, tetraalkylammonium and phosphonium hydroxides, metal alkoxides and amides, metal silanoates, inorganic salts, oxides, carbonates, bicarbonates, sulfates, and mixtures thereof.

In alternative embodiments, the thermal energy management systems as provided, or the method for managing thermal energy as provided herein, herein further comprise, or further comprise use of, an acid neutralizing agent, wherein optionally the acid neutralizing agent is selected from the group consisting of: hydrogen halides, inorganic acids, sulfonic acids, carboxylic acids, phenols, bisulfates, and a mixture thereof.

In alternative embodiments, the thermal energy management systems as provided, or the method for managing thermal energy as provided herein, herein further comprise, or further comprise use of, an ion exchange resin, wherein optionally the ion exchange resin is selected from the group consisting of: strong anionic, weak anionic, strong cationic, weak cationic, and a mixture thereof.

In alternative embodiments, provided are thermal energy management systems comprising all, or a subsection, of the thermal energy management system as illustrated in FIG. 1.

The details of one or more embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### BRIEF DESCRIPTION OF THE DRAWINGS

FIG. 1 is a schematic representation of an exemplary thermal energy management system as provided herein.

Reference will now be made in detail to various exemplary embodiments as provided herein. The following detailed description is provided to give the reader a better understanding of certain details of aspects and embodiments of the invention, and should not be interpreted as a limitation on the scope of the invention.

### DETAILED DESCRIPTION OF THE INVENTION

In alternative embodiments, provided are thermal energy management systems and methods of using them, for the efficient storage and transfer of energy.

In alternative embodiments, systems and methods as provided herein use one or more phase change materials (PCMs), which are substances with a high heat of fusion that is capable of storing or releasing large amounts energy during crystallization and melting, respectively. In alternative embodiments, a solid-to-liquid PCM is used that, when reaching its melting point, releases a large amount of energy without the material undergoing an appreciable change in temperature. In alternative embodiments a liquid state PCM is used, which, when reaching its crystallization point, stores a large amount of energy without the material undergoing an appreciable change in temperature. The heat stored or released during crystallization and melting, respectively, is referred to as “latent” heat.

In alternative embodiments, in order to decrease the exposure of PCMs to their surrounding environment, systems as provided herein incorporate a number of techniques to encapsulate the PCMs in a protective barrier using a variety of shells and composite materials. Systems as provided herein can incorporate any encapsulation process, e.g., where small particles or droplets of PCM are covered or encased in or within a coating, shell, or embedded in a matrix producing capsules. This increases the number of practical applications for a given material. The encapsulation process creates a barrier or shell entrapping the core material preventing contact with the outside environment. In alternative embodiments, encapsulation improves chemical compatibility. In alternative embodiments, capsules or shells are designed such that they do not rupture, or the core phase change material does not permeate through the shell over time. In alternative embodiments, use of such encapsulation allows use of otherwise corrosive PCM, preventing its released in its surrounding environment where the thermal energy storage system's materials would be suspect to degradation.

In alternative embodiments, provided are thermal energy storage systems comprising an encapsulated or contained PCM with high latent heat and optionally other favorable thermal storage properties, as well as a neutralizing agent or an ion exchange resin that, should the structural integrity of one or more capsules or containers in the system become compromised, will react with the PCM to generate a product that does not damage or degrade the other materials or components of the system.

In alternative embodiments, PCMs suitable for use in accordance with the systems and methods as provided herein include or comprise, without limitation, fatty acids, fatty acid derivatives, salt hydrates, eutectic mixtures, organic phase change materials which possess acidic or basic properties, and mixtures thereof.

The neutralizing agent in alternative embodiments can be an acid, a base, or an ion exchange resin, depending on the PCM used in a particular embodiment. Embodiments comprising the use of an acidic PCM further comprise the use of a basic neutralizing agent, e.g. organolithiums, amines, N-heterocyclic compounds, tetraalkylammonium and phosphonium hydroxides, metal alkoxides and amides, metal silanoates, inorganic salts, oxides, carbonates, bicarbonates, sulfates, and mixtures thereof. Embodiments comprising the use of a basic PCM can further comprise the use of an acidic neutralizing agent, e.g. hydrogen halides, inorganic acids, sulfonic acids, carboxylic acids, phenols, bisulfates, and a mixture thereof. Embodiments comprising the use of a basic PCM further comprise the use of a cationic ion exchange resin. Embodiments comprising the use of an acidic PCM can further comprise the use of an anionic ion exchange resin.

In alternative embodiments, when referred to herein, “free” PCM is any PCM that has leached, permeated, or otherwise leaked from one or more of the PCM-containing capsules and into its surrounding environment. If the structural integrity of one or more of the PCM-containing capsules is compromised, leading to the release of free PCM, the neutralizing agent and/or the ion exchange resin reacts with the PCM to generate a benign, non-reactive, and non-toxic product, thereby increasing the lifecycle of the thermal energy management system and reducing risks associated with material corrosion or degradation. In a thermal energy management system comprising an encapsulated acidic or basic PCM, a release of even a small amount of free PCM into the surrounding environment could pose an operational risk and necessitate the replacement of one or more components of the thermal management system. Neutralization of the free PCM can allow for uninterrupted operation of the thermal management system, even if the structural integrity of one or more of the PCM-containing capsules becomes compromised and some quantity of PCM is released.

The use of a neutralizing agent in alternative embodiments provides additional benefits to the thermal energy storage systems. One such benefit is a reduction in costs associated with toxic waste management. Without the addition of a neutralizing agent, the operator of a thermal energy storage system may need to provide various preventative measures to ensure that potentially hazardous free PCMs are not released into their surrounding environments. Through the addition of a neutralizing agent and/or ion exchange resin, free PCM is rendered non-hazardous and toxic waste prevention and disposal costs may therefore be reduced.

In alternative embodiments, provided are thermal energy storage systems comprising one or more tanks or other suitable vessels, each comprising a plurality of acidic or basic PCM-containing capsules and a fluid comprising an acidic or basic neutralizing agent that reacts with any free PCM present in the system or a fluid which flows through an ion exchange resin bed, as well as a heat source that is operationally connected to the tank comprising the PCM capsules and the fluid. In alternative embodiments, the PCM is an acid, the neutralizing agent is a base and the free PCM is neutralized via an acid-base reaction. In other embodiments, the PCM is a base, the neutralizing agent is an acid and the free PCM is neutralized via an acid-base reaction. In alternative embodiments, the PCM is an acid, the ion exchange resin is an anionic ion resin and the free PCM is neutralized via an acid-base reaction. In other embodiments, the PCM is a base, the ion exchange resin is a cationic ion exchange resin and the free PCM is neutralized via an acid-base reaction.

In alternative embodiments, the fluid comprising the neutralizing agent or flowing through the ion exchange resin bed acts as a heat transfer medium and serves to manage heat away from a heat-generating source and into the tank, or tanks, comprising the PCM-containing capsules. First, the fluid undergoes a heat exchange with the heat source through any method known in the art, e.g. direct contact. The heated fluid is then transferred to the one or more tanks comprising the PCM capsules. Upon entering the tank, the heated fluid directly contacts the PCM capsules wherein heat is transferred from the fluid to the capsules as the PCM reaches its melting point and undergoes a phase change. The now lower-energy fluid is then transferred back to the heat source wherein heat is transferred from the heat source and into the fluid. The process is repeated in a continuous, circulatory fashion.

The fluid can be any fluid suitable for use as a heat transfer medium that will not react with the neutralizing agent or ion exchange resin (or both the neutralizing agent and the ion exchange resin, if both are used) or inhibit their reactivity with free PCM. In alternative embodiments, the fluid is water to which some amount of the neutralizing agent has been added. The amount of the neutralizing agent in the fluid can be, for example, a molar ratio of PCM to neutralizing agent of about 1.0:0.1, although those skilled in the art would recognized that certain embodiments would require more or less neutralizing agent relative to the amount of PCM in the system, depending on particular conditions of a given embodiment such as the solubility of the neutralizing agent in the heat transfer medium or the like. In alternative embodiments, the fluid comprises water flowing through an ion exchange resin bed incorporated into the system. The ion exchange bed volume can be adjusted to neutralize or adsorb a certain amount of free PCM before the resin must be regenerated. Those skilled in the art would recognized that certain embodiments would require different bed volumes relative to the amount of PCM in the system without adversely affecting the heat transfer medium's flow through the bed.

In alternative embodiments, the heat source is an industrial process or apparatus that is heat generating. It is known in the art that a large number of industrial processes, e.g. manufacturing processes, power plants, petroleum and gas refineries, chemical production facilities, waste processing facilities, and the like utilize processes and equipment that generate a significant amount of heat that must be managed away from the process or equipment in order to maintain optimal operating conditions. In many such instances, thermal energy storage systems are used to manage heat away from the heat generating source or its surrounding environment. Provided are improved heat management systems for use in the foregoing industrial settings.

In alternative embodiments, the heat source is system or apparatus that is undergoing heat exchange with a naturally occurring thermal energy source, for example, solar energy or geothermal energy. In such embodiments, passive thermal energy is captured using a heat collection device comprising the heating of a fluid via heat-exchange, e.g. a passive solar-thermal system, or a geothermal heat pump. The heated fluid comprising the neutralizing agent and/or flowing through the ion exchange resin is then directed to one or more tanks comprising the encapsulated PCM, wherein heat is transferred from the fluid to the PCM-containing capsules and stored. The fluid can then be re-circulated from the tanks to the heat source in a continuous fashion, thereby providing for improved thermal energy management relative to similar systems without PCMs.

Exemplary embodiments provide for thermal management systems for maintaining an optimal temperature of a building. In such embodiments, heat is generated using either an active heating system, e.g. a generator or furnace, or a passive heating system, e.g. a passive solar thermal system, and a heat-transfer fluid comprising a neutralizing agent and/or flowing through an ion exchange resin is circulated between the building and a tank or vessel, or group of vessels, comprising encapsulated PCM, the selected phase change temperature of the PCM being close to that of the optimal temperature for the building, e.g. approximately 70° F. Due to the use of the PCM. The system acts as a passive thermal management system by storing heat absorbed from the heat transfer fluid as it undergoes a solid-to-liquid phase change, thereby preventing the building from reaching a temperature that is significantly above the optimal temperature range, and releasing the stored energy into the building as the it undergoes a liquid-to-solid phase change, thereby reducing the amount of energy required to heat the building during times when heat is not being directly supplied to the heat transfer medium.

In alternative embodiments, thermal management systems comprise or incorporate the modification of existing thermal energy management systems. In such embodiments, thermal management systems are modified by the addition of PCM-containing capsules to cooling towers (or other vessels wherein a heat transfer medium is stored) and by the addition of a neutralizing agent and/or the incorporation of an ion exchange resin into the system to the heat transfer medium therein. In an exemplary embodiment, an existing thermal management system comprising a circulated heat exchange fluid acting as a heat transfer medium and a cooling tower, or group of cooling towers is modified to include PCM-containing capsules in the cooling tower and a neutralizing agent in the heat transfer medium and/or the heat transfer medium flowing through an ion exchange resin. The heat transfer medium is first heated by heat exchange to above the melting point of the selected PCM. The heated fluid is then directed to the cooling tower or group of towers comprising the PCM-containing capsules wherein heat is transferred from the fluid to the PCM, some amount of which is stored by the PCM in the form of latent heat as the PCM is melted. The now lower-energy fluid is then circulated back to the heat source wherein it is heated to above the melting point of the PCM.

In alternative embodiments, provided are methods for managing thermal energy comprising: providing an encapsulated PCM, the PCM being comprising an acid or a base, contacting the encapsulated PCM with a heat-transfer medium, wherein the medium comprises an acidic or basic neutralizing agent and/or the heat transfer medium flows through an ion exchange resin bed, and circulating the heat transfer medium from an area with a temperature above the melting point of the PCM, to an area comprising the encapsulated PCMs.

In alternative embodiments, provided are methods of managing the temperature of a building comprising: providing a plurality of capsules containing an acidic or basic PCM, the selected PCM having a melting point of approximately the desired temperature of the interior of the building, heating a fluid comprising a substance or flowing through a resin capable of neutralizing the acidic or basic PCM to above the PCM's melting point, should any of the PCM leak from any of the capsules, contacting the fluid with the PCM-containing capsules, thereby causing the PCM to undergo a solid-to-liquid phase change by absorbing thermal energy from the fluid, and releasing the thermal energy into the building as the temperature of the interior of the building drops to below that of the crystallization temperature of the PCM.

In alternative embodiments, the capsules encapsulating the PCMs are made of, or are comprised of, a generally continuous and impermeable or semi-impermeable polymer, or of a plastic, metal, or other suitable impermeable or semi-impermeable structure. In alternative embodiments, the materials that contain the PCM are flexible and allow for a change in volume of the PCM core without compromising the structural integrity of the capsule or container's structure. In alternative embodiments, the shells or containers are impermeable and do not allow for the core material to be released into the surrounding environment during the useful life of the particles. This is desirable in certain embodiments in which the selected PCM needs to be isolated from its surrounding environment due to toxicity or corrosiveness.

The present invention is further defined in the following Examples. It should be understood that these examples, while indicating preferred or exemplary embodiments, are given by way of illustration only and are not to be construed as limiting in any manner. From the above discussion and these examples, one skilled in the art can ascertain the essential characteristics of this invention, and without departing from the spirit and scope thereof, can make various changes and modifications of the invention and embodiments provided herein to adapt it to various usages and conditions.

### EXAMPLES

### Example 1: Solar Latent Heat Thermal Storage System (LHTES) Comprising an Acidic PCM and a Neutralizing Agent

The following example describes a solar LHTES used to maintain a desired temperature range, or to raise the temperature, in any structure, including an industrial or a domestic building or facility, a storage facility, a boat, a train carriage, and the like. The LHTES is comprised of a heat storage tank, wherein encapsulated fatty acid derivative PCMs are placed. The system further comprises solar plate collectors, a circulating pump, a heat transfer medium comprising water and sodium hydroxide, or equivalents, as a neutralizing agent and wherein the molar ratio of PCM to sodium hydroxide, or equivalents, is approximately 1.0:0.1, a valve system to direct the flow of heat transfer medium throughout the system, and a series of pipes connecting the building and the heat storage tank, through which the heat transfer medium is circulated.

In alternative embodiments, the heat storage tank comprises a plurality of capsules comprising at least one fatty acid derivative with a melting/crystallization temperature approximately 29° C., which is a comfortable “room temperature” of a building. During the “charging” process, the heat transfer medium is circulated between the solar plate collector and heat storage tank in a continuous fashion. When in contact with the solar plate collectors, thermal energy is transferred from the collectors and into the heat transfer medium. When the heat transfer medium comes into contact with the PCM-containing capsules in the tank, sensible heat absorbed by the heat transfer medium is then transferred to the PCM. The PCM is continuously heated by sensible heat throughout the day until the PCM is heated to above its melting point. During the melting process, heat is stored in the PCM as latent heat and the PCM maintains a constant temperature as the PCM and heat transfer medium reach equilibrium.

During the evening and nighttime hours, or daytime hours as appropriate (e.g. cold weather), when a reduction in solar energy causes the building's temperature to drop below the room temperature, the valve system is opened and the heat transfer medium is moved through the series of pipes in the building, allowing the stored thermal energy to be released into the building, thereby increasing the building's temperature passively. During the discharging process, the heat transfer medium releases thermal energy as it travels within the piping system in the building. When the discharged heat transfer medium re-enters the tank, the PCM releases stored latent heat back into the heat transfer medium, which is then re-circulated through the piping system, allowing for a continuous heating process until the building's temperature reaches approximately the melting/crystallization temperature of the PCM, i.e. approximately 29° C. Once the piping system and building reach a temperature equilibrium (29° C.), the LHTES will maintain this temperature by releasing or absorbing heat at a constant temperature. This process will continue until the PCM has exhausted all stored latent heat. The charging process will be repeated the following day during the day time hours.

Fatty acids are considered weak acids, but are corrosive and damaging to materials overtime causing degradation and oxidation, resulting in a more rapid depreciation of the system. To prevent the free fatty acid from degrading the LHTES materials, the sodium hydroxide neutralizing agent reacts with the fatty acid, producing a carboxylate salt (soap) product that is compatible with the LHTES materials.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from this disclosure processes, machines, manufacture, compositions of matter, means, methods, or steps, presently existing or later to be developed that perform substantially the same function or achieve substantially the same result as the corresponding embodiments described herein may be utilized as provided herein. Accordingly, the appended claims are intended to include within their scope such processes, machines, manufacture, compositions of matter, means, methods, or steps.

What is claimed is:

1. A thermal energy management system comprising:
a. at least a first container or compartment and a second container or compartment, each defining or having an interior volume or interior compartment;
wherein the first container or compartment and the second container or compartment are in operable connection to each other such that a fluid or heat transfer medium initially stored in the second container or compartment can pass to or into the first container or compartment;
and optionally the operable connection comprises a valve or a valve system capable of directing or controlling the flow of the fluid or heat transfer medium from the second container or compartment to or into the first container or compartment;
and optionally the system further comprises an operable connection between the first container or compartment and the second container or compartment such that the fluid or heat transfer medium can be re-circulated from the first container or compartment back to the second container or compartment in a continuous fashion;
b. a plurality of capsules stored or contained in the first container or compartment, wherein the plurality of capsules comprise, or have contained within an interior volume, at least one acidic or basic phase change material (PCM);
c. a heat source operationally connected to the second container or compartment, wherein the heat source is capable of heating the fluid or heat transfer medium in the second container or compartment to above the melting point of the PCM; and
d. a fluid or heat transfer medium stored or contained in the second container or compartment, wherein the fluid or heat transfer medium comprises a composition or a material, or the fluid or heat transfer medium itself is, capable of reacting with the PCM to generate a neutral, non-reactive product;
wherein the fluid or heat transfer medium absorbs sufficient thermal energy from the heat source to heat the fluid or heat transfer medium to above the melting point of the PCM, and the heated fluid or heat transfer medium is subsequently transferred from the second container or compartment to the first container or compartment, thereby heating the PCM in the plurality of capsules to above the melting point of the PCM and removing at least a portion of the thermal energy from the fluid or heat transfer medium and storing it in the PCM as a latent heat.

2. The thermal energy management system of claim 1, wherein the PCM has a latent heat value of 160 J/g or higher.

3. A method for managing thermal energy comprising:
a. providing an encapsulated PCM, wherein the PCM is comprised of an acid or a base, or the PCM is an acidic or a basic phase change material (PCM);
b. providing:
(i) a heat transfer medium comprising an acid or basic neutralizing agent, and when sufficiently heated the heat transfer medium is capable of heating the PCM to above the melting point of the PCM, and/or
(ii) an ion exchange resin capable of neutralizing or adsorbing the PCM comprised of an acid or base or an acidic or a basic PCM;
c. heating the heat transfer medium in a first area or compartment with a temperature above the melting point of the PCM; and
d. circulating the heated heat transfer medium from the first area or compartment to a second area or compartment comprising the encapsulated PCM, thereby contacting the encapsulated PCM with the heat-transfer medium and both neutralizing the acidic or basic PCM, circulating the heat transfer medium through the ion exchange resin neutralizing the acidic or basic free PCM, and heating the PCM to a temperature above the melting point of the PCM,
wherein optionally the PCM is an acidic PCM, and optionally the PCM is or comprises at least one a fatty acid or a fatty acid derivative, and optionally the fatty acid comprises a C2 to C40, or C3 to C30, alkyl or alkene chain, or comprises a substituted C2 to C40, or C3 to C30, alkyl or alkene chain.

4. The thermal energy management system of claim 1, wherein the PCM is an acidic PCM, and optionally the PCM is or comprises at least one a fatty acid or a fatty acid derivative, and optionally the fatty acid comprises a C2 to C40, or C3 to C30, alkyl or alkene chain, or comprises a substituted C2 to C40, or C3 to C30, alkyl or alkene chain.

5. The thermal energy management system of claim 1, wherein the PCM is a basic PCM, an ester, a salt hydrate, an eutectic mixture or a combination thereof.

6. The method of claim 3, wherein the PCM is a basic PCM, an ester, a salt hydrate, an eutectic mixture or a combination thereof.

7. The thermal energy management system of claim 1, further comprising, or further comprising use of, a basic neutralizing agent, wherein optionally the basic neutralizing agent is selected from the group consisting of: organolithiums, amines, N-heterocyclic compounds, tetraalkylammonium and phosphonium hydroxides, metal alkoxides and amides, metal silanoates, inorganic salts, oxides, bicarbonates, carbonates, sulfates, and mixtures thereof.

8. The method of claim 3, further comprising, or further comprising use of, a basic neutralizing agent, wherein optionally the basic neutralizing agent is selected from the group consisting of: organolithiums, amines, N-heterocyclic compounds, tetraalkylammonium and phosphonium hydroxides, metal alkoxides and amides, metal silanoates, inorganic salts, oxides, bicarbonates, carbonates, sulfates, and mixtures thereof.

9. The thermal energy management system of claim 1, or the method of claim 3, further comprising, or further comprising use of:
(a) an acid neutralizing agent, wherein optionally the acid neutralizing agent is selected from the group consisting of: hydrogen halides, inorganic acids, sulfonic acids, carboxylic acids, phenols, bisulfates, and a mixture thereof; or
(b) an ion exchange resin, wherein optionally the ion exchange resin is selected from the group consisting of: strong anionic, weak anionic, strong cationic, weak cationic, and a mixture thereof.

10. The method of claim 3, further comprising, or further comprising use of:
(c) an acid neutralizing agent, wherein optionally the acid neutralizing agent is selected from the group consisting of: hydrogen halides, inorganic acids, sulfonic acids, carboxylic acids, phenols, bisulfates, and a mixture thereof; or
(d) an ion exchange resin, wherein optionally the ion exchange resin is selected from the group consisting of: strong anionic, weak anionic, strong cationic, weak cationic, and a mixture thereof.

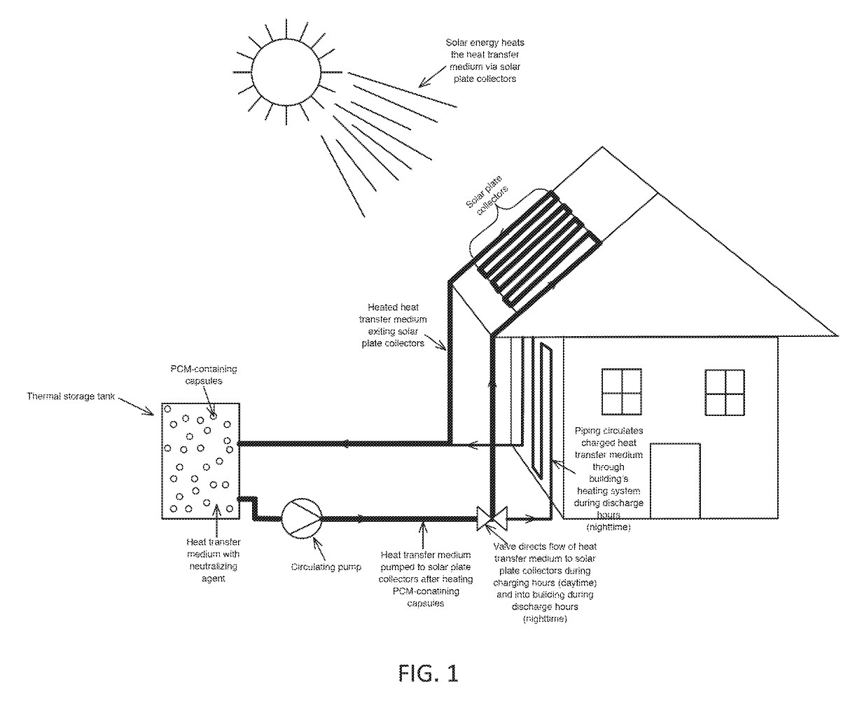

11. A thermal energy management system as illustrated in FIG. 1.
